(19) United States
(12) Patent Application Publication
(10) Pub. No.: US 2010/0323201 A1
(43) Pub. Date: Dec. 23, 2010

(54) Polymeric Thermoplastic Compositions Having Excellent Resistance to Moisture and Oxygen Transmission and Sheet Which are Made of These Polymeric Thermoplastic Compositions

(75) Inventors: Inhun Son, Daejeon (KR); Minho Jeon, Daejeon (KR); Myungahn Ok, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: SK ENERGY CO., LTD., Seoul (KR)

(21) Appl. No.: 12/816,000

(22) Filed: Jun. 15, 2010

(30) Foreign Application Priority Data
Jun. 18, 2009 (KR) 10-2009-0054160

(51) Int. Cl. B32B 27/00; C08G 59/00; C08L 63/00

(52) U.S. Cl. 428/412; 528/405; 525/523

(57) ABSTRACT

Disclosed is a resin composition for blocking oxygen and moisture, and a sheet for blocking oxygen and moisture manufactured by using thereof, in which the resin composition includes polycarbonate terpolymer produced by reacting different two epoxides compounds with carbon dioxide.

### TECHNICAL FIELD

The present invention relates to a resin composition for manufacturing a film or a sheet that is used in a field of a food package, and more specifically to a resin composition having an excellent effect for blocking oxygen and moisture.

### BACKGROUND ART

A nylon, ethylene vinyl alcohol (EVOH), and the like recently used in a field of a food package have an excellent gas barrier property, but does not have a good moisture barrier property, and specifically the gas barrier property is sharply decreased according to humidity.

An aliphatic polycarbonate is a polymer that is easily biodegraded, and has an excellent gas and moisture barrier properties, so that it can be usefully used as package materials or coating materials. The aliphatic polycarbonate is produced from epoxide compound and carbon dioxide. Because it does not use phosgene that is a harmful compound, and carbon dioxide is not expensive, it has a high environment-friendly value.

U.S. Pat. No. 4,142,021 discloses a method for applying an oxygen barrier property of polyethylene carbonate (PEC) and polypropylene carbonate (PPC) on one layer of multi-film. However, glass transition temperatures of polyethylene carbonate and polypropylene carbonate resin are 25° C. and 40° C., respectively. Therefore, there are disadvantages that a dimensional stability is not maintained when molding a film, and when storing a film or sheet that is winded to a roll, one sticks to another due to a sticky of a surface. On this account, it cannot be used as a single film and it should be used with other polymer that has an excellent dimensional stability as a laminated structure. In addition, there is a further disadvantage that oxygen and moisture barrier properties are sharply decreased at temperature above glass transition temperature.

### DISCLOSURE

### Technical Problem

To solve the above-mentioned problems, an object of the present invention is to provide a film or sheet having an excellent oxygen and moisture barrier effects, and an improved dimensional stability and adhesion property by controlling glass transition temperature through copolymering various epoxides with comonomer.

### Technical Solution

To achieve the above object, the present invention provides a resin composition using aliphatic polycarbonate that has an improved oxygen and moisture barrier properties by controlling glass transition temperature and has an improved dimensional stability and surface adhesion property. The resin composition of the present invention means a composition for manufacturing a general film or sheet, but will not be limited thereto, various production, such as liquid, pellet, master batch, and the like can be possible according to a way for manufacturing a film or sheet. Specifically, additives, such as dyes, pigments, fillers, antioxidants, UV blocking agents, antistatic agents, anti-blocking agents, slip agents, and the like, that are generally used in manufacturing a film or sheet, can be further added, and a kind of additives will not be limited.

More specifically, the present invention relates to the resin composition for blocking oxygen and moisture, including polycarbonate terpolymer produced by reacting carbon dioxide with different two epoxide compounds.

The inventors have been perfected the present invention from the results that a property of polycarbonate terpolymer can be easily controlled due to the difference of glass transition temperatures of epoxides when producing polycarbonate terpolymer by using different two epoxides compounds. In other words, when producing polycarbonate copolymer by reacting existing ethylene oxide or propylene oxides with carbon dioxide, there are disadvantages that the dimensional stability is not maintained at room temperature due to the glass transition temperature is 25˜40° C., and when winding to a roll, one film sticks to another films. However, the present invention can control that the glass transition temperature is adjusted at very high level, i.e., 40˜110° C.

In addition, the sheet using the resin composition according to the present invention is within the scope of the present invention. For the present invention, the sheet includes the film, and more specifically, if its thickness is less than 0.2 mm, it is the film, and if its thickness is above 0.2 mm, it is the sheet. The present invention includes the film and the sheet as mentioned above. In addition, the film of the present invention includes a stretch film or non-stretch film.

The epoxide compound of the present invention may be selected from group consisting of substituted or un-substituted (C2-C10) alkylene oxide with halogen or alkoxy; substituted or un-substituted (C4-C20) cyclo alkylene oxide with halogen or alkoxy; and substituted or un-substituted (C8-C20) styrene oxide with halogen, alkoxy, alkyl or aryl.

The alkoxy concretely includes alkyloxy, aryloxy, aralkyloxy, and the like, and an example of the aryloxy includes phenoxy, biphenyloxy, naphthyoxy, and the like. The alkoxy, alkyl and aryl may have substituted groups selected from group consisting of halogen element or alkoxy group.

More specifically, polycarbonate terpolymer of the present invention is represented by the following general formula (1)

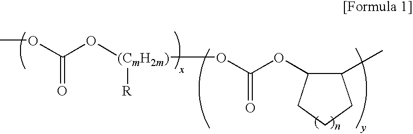

where: m is 2˜10, n is 1˜3, R is hydrogen, (C1-C4) alkyl or —CH₂—O—R′ (R′ is (C1-C8) alkyl), and x:y=5:95˜95:5.

For the present invention, a definite example of the epoxide compound includes ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxidenobonene, limonene oxide, dieldrin, 2,3-epoxidepropylbenzene, styrene oxide, phenylpropylene oxide, stilbene oxide, chlorostilbene oxide, dichlorostilbene oxide, 1,2-epoxy-3-penoxypropane, benzyloxymethyl oxirane, glycidyl-methylphenyl ether, chlorophenyl-2, 3-epoxidepropyl ether, epoxypropyl methoxyphenyl ether biphenyl glycidyl ether, glycidyl naphthyl ether, and the like.

The polycarbonate terpolymer represented by the above general formula (1) is desirable because the polycarbonate terpolymer has an improved oxygen and moisture barrier properties, and also an improved adhesive property, due to 40˜110° C. of its glass transition temperature (T_{g}).

A polymerization of the polycarbonate terpolymer represented by the above general formula (1) may be performed by a solution polymerization or bulk polymerization, and more specifically, may be performed by injecting different two epoxides compounds and carbon dioxide under presenting of a catalyst using an organic solvent as a reaction medium. The solvent may use one or at least two selected and combined from group consisting of aliphatic hydrocarbon, such as pentane, octane, decane and cyclohexane, etc., aromatic hydrocarbon, such as benzene, toluene, xylene, etc., and a halogenated hydrocarbon, such as chloromethane, methylenechloride, chloroform, carbontetrachloride, 1,1-dichloroethan, 1,2-dichloroethan, ethylchloride, trichloroethan, 1-chloropropane, 2-chloropropane, 1-chlorobutane, 2-chlorobutane, 1-chloro-2-methylpropane, chlorobenzene, bromobenzene, etc. A pressure of carbon dioxide can be possible up to 100 pressures at ambient pressure, and preferably, the pressure is 5 to 30 pressure. The polymerization temperature of co-polymerization reaction is possible to 20˜120° C., preferably 50˜90° C. More preferably, using monomer itself as solvent may perform the bulk polymerization.

The catalyst includes at least one of functional groups represented by the following general formulas (2) to (4) as described in Patent No. 10-0853358 that was filed and registered by the applicant of the present invention. In addition, a complex compound as the catalyst can be used, in which a central metal of the complex compound is Lewis acid group. As described in Application No. 10-2008-0074435, the complex compound represented by the following general formula (5) or the complex compound represented by the following general formula (6) can be used as the catalyst. However, it will not be limited thereto.

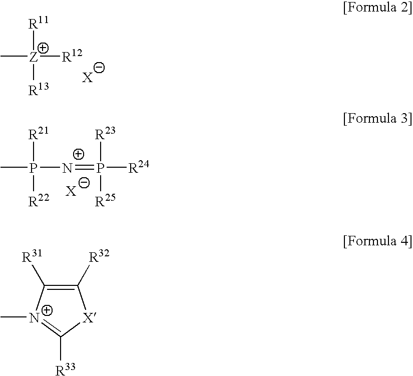

where: Z is nitrogen or phosphorous atom;

X is halogen atom; amido, C1 to C20 alkylsulfonate, C1 to C20 alkoxy, C1 to C20 carboxy, C6 to C20 aryloxy with or without at least one of nitrogen atom, oxygen atom, silicon atom, sulfur atom, and phosphorous atom, and X may be coordinated in the central metal having Lewis acid group;

R¹¹, R¹², R¹³, R²¹, R²², R²³, R²⁴, and R²⁵ is independently or simultaneously C7 to C20 arylalkyl radical, C7 to C20 alkylaryl radical, C2 to C20 alkenyl radical, or C1 to C20 alkyl radical with or without at least one of halogen atom, nitrogen atom, oxygen atom, silicon atom, sulfur atom, and phosphorous atom; or metalloid radical of Group-14 metal substituted with hydrocarbyl, two of R¹¹, R¹², and R¹³ or two of R²¹, R²², R²³, R²⁴, and R²⁵ may be coupled each other and formed in a ring;

R³¹, R³², and R³³ is independently or simultaneously hydrogen radical; C7 to C20 arylalky radical, C7 to C20 alkylaryl radical, C2 to C20 alkenyl radical, or C1 to C20 alkyl radical with or without at least one of halogen atom, nitrogen atom, oxygen atom, silicon atom, sulfur atom, and phosphorous atom; or metalloid radical of Group-14 metal substituted with hydrocarbyl, two of R³¹, R³², and R³³ may be coupled each other and formed in a ring;

X′ is oxygen atom, sulfur atom, or N—R (here, R is hydrogen radical; C7 to C20 arylalkyl radical, C7 to C20 alkylaryl radical, C2 to C20 alkenyl radical, or C1 to C20 alkyl radical with or without at least one of halogen atom, nitrogen atom, oxygen atom, silicon atom, sulfur atom, and phosphorous atom).

[LₐMX_{b}]X_{c} [Formula 5]

where: M is metal atom;

L is L-type or X-type ligand;

a is 1, 2, or 3, when a is 1, L includes at least two of protons, when a is 2 or 3, each L may be same or different, or be coupled and be chelationed to metal as a bidentate or tridentate ligand, at least one L includes at least one proton, a total number of protons included in L is at least 2, X is independently or simultaneously halogen anion; BF₄⁻; ClO₄⁻; NO₃⁻; PF₆⁻; HCO₃⁻; C1 to C20 carboxy anion, C6 to C20 aryloxy anion with or without at least one of halogen atom, nitrogen atom, oxygen atom, silicon atom, sulfur atom, and phosphorous atom; C1 to C20 alkoxy anion; C1 to C20 carbonate anion; C1 to C20 alkylsulfonate anion; C1 to C20 amide anion; C1 to C20 carbamate anion;

b and c satisfy with a relation of “(b+c)=(a total number of protons included in L)+[(an oxidation number of metal)−(a number of X-type ligand in L)].

[L₄M]⁻[X . . . H . . . X]⁻ₐZ⁻_{b} [Formula 6]

where: M is cobalt (III) or chrome (III);

L is an anionic X-type ligand, each L may be same or different each other, or be coupled and be a bidentate, tridentate, or tetradentate ligand, at least one of 4 L includes 4^{th} ammonium cation, a total number of ammonium cation included in L₄ is 1+a+b, and the complex compounds are wholly neutral compounds;

X is independently or simultaneously halogen anion; HCO₃⁻; C1 to C20 carboxy anion, C6 to C20 aryloxy anion with or without at least one of halogen atom, nitrogen atom, oxygen atom, silicon atom, sulfur atom, and phosphorous atom; C1 to C20 alkoxy anion; C1 to C20 carbonate anion; C1 to C20 alkylsulfonate anion; C1 to C20 amide anion; C1 to C20 carbamate anion;

Z is BF₄⁻, ClO₄⁻, NO₃⁻, or PF₆⁻.

More specifically, the catalyst is a compound represented by the following general formulas (7) to (10).

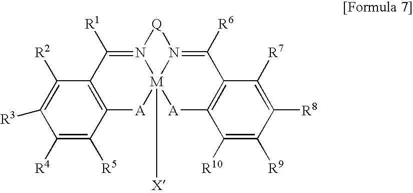

where: M is a transition metal or a typical metal;

x′ is a neural or anion 1^{st} ligand;

A is oxygen or sulfur atom;

Q is C1 to C20 dioxy radical, C6 to C30 aryl diradical, C3 to C20 cycloalkyl diradical, or C1 to C20 alkyl with or without at least one of halogen atom, nitrogen atom, oxygen atom, silicon atom, sulfur atom, and phosphorous atom, R¹ to R¹⁰ is independently or simultaneously C7 to C20 arylalkyl radical, C7 to C20 alkylaryl radical, C2 to C20 alkenyl radical, or C1 to C20 alkyl radical with or without at least one of halogen atom, oxygen atom, silicon atom, sulfur atom, and phosphorous atom; or metalloid radical of Group-14 metal substituted with hydrocarbyl, two of R¹ to R¹⁰ may be coupled each other and formed in a ring, at least one of R¹ to R¹⁰ include at least one of functional groups of the above general formulas (2), (3), and (4), and X in the general formulas (2), (3), and (4) may be coordinated in the central metal having Lewis acid group.

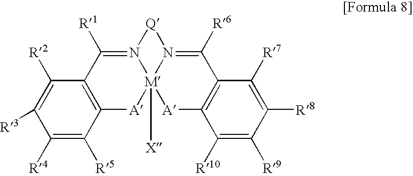

where: M′ is cobalt;

X″ is halogen atom, C1 to C20 aryl oxy substituted or un-substituted with nitro group, or C1 to C20 carboxy substituted or un-substituted with halogen, A′ is oxygen atom, Q′ is trans-1,2-cyclohexylene, ethylene, or substituted ethylene, R′¹, R′², R′⁴, R′⁶, R′⁷, and R′⁹ are hydrogen, R′⁵ and and R′¹⁰ are tert-butyl, methyl, or isopropyl, at least one of R′³ and R′⁸ are —[YR⁴¹₃₋ₘ{(CR⁴²R⁴³)ₙN³R⁴⁴R⁴⁵R⁴⁶}ₘ]X″ₘ, or —[PR⁵¹R⁵²═N═PR⁵³R⁵⁴R⁵⁵]X″, in this case Y is C or Si, X″ is halogen atom, C1 to C20 aryloxy substituted or un-substituted with nitro group, or C1 to C20 carboxy substituted or un-substituted with halogen, R⁴¹, R⁴², R⁴³, R⁴⁴, R⁴⁵, R⁴⁶, R⁵¹, R⁵², R⁵³, R⁵⁴, and R⁵⁵ are independently or simultaneously C7 to C20 arylalkyl radical, C7 to C20 alkylaryl radical, C2 to C20 alkenyl radical, or C1 to C20 alkyl radical with or without at least one of halogen atom, nitrogen atom, oxygen atom, silicon atom, sulfur atom, and phosphorous atom; or metalloid radical of Group-14 metal substituted with hydrocarbyl, two of R⁴⁴, R⁴⁵, and R⁴⁶, or two of R⁵¹, R⁵², R⁵³, R⁵⁴, and R⁵⁵ may be coupled each other and formed in a ring, m is one integer of 1 to 3, and n is one integer of 1 to 20.

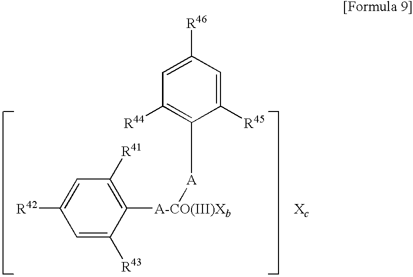

where: X is independently or simultaneously halogen anion; BF₄⁻; ClO₄⁻; NO₃⁻; PF₆⁻; HCO₃⁻; C1 to C20 carboxy anion, C6 to C20 aryloxy anion with or without at least one of halogen atom, nitrogen atom, oxygen atom, silicon atom, sulfur atom, and phosphorous atom; C1 to C20 alkoxy anion; C1 to C20 carbonate anion; C1 to C20 alkylsulfonate anion; C1 to C20 amide anion; C1 to C20 carbamate anion;

R⁴¹, R⁴², R⁴³, R⁴⁴, R⁴⁵, and R⁴⁶ are selected from group consisting of hydrogen, tert-butyl, methyl, ethyl, isopropyl, and —[YR⁵¹₃₋ₘ{(CR⁵²R⁵³)ₙN⁺R⁵⁴R⁵⁵R⁵⁶}ₘ], and at least one of R⁴¹, R⁴², R⁴³, R⁴⁴, R⁴⁵, and R⁴⁶ is —[YR⁵¹₃₋ₘ{(CR⁵²R⁵³)ₙN⁺R⁵⁴R⁵⁵R⁵⁶}ₘ] (here, Y is carbon or silicon atom, R⁵¹, R⁵², R⁵³, R⁵⁴, R⁵⁵, and R⁵⁶ are independently or simultaneously hydrogen radical; C7 to C20 arylalkyl radical, C7 to C20 alkylaryl radical, C2 to C20 alkenyl radical, or C1 to C20 alkyl radical with or without at least one of halogen atom, nitrogen atom, oxygen atom, silicon atom, sulfur atom, and phosphorous atom; or metalloid radical of Group-14 metal substituted with hydrocarbyl, two of R⁵⁴ , R⁵⁵ and R⁵⁶ may be coupled each other and formed in a ring, m is one integer of 1 to 3, n is one integer of 1 to 20, b+c−1 value is same integer value with a sum of total —[YR⁵¹₃₋ₘ{(CR⁵²R⁵³)ₙN⁺R⁵⁴R⁵⁵R⁵⁶}ₘ] included in the complex compound of the above general formula (9).

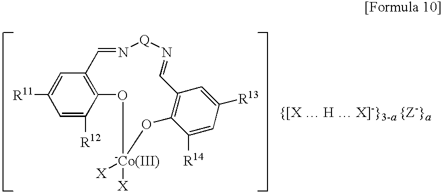

where: X is independently or simultaneously halogen anion; HCO₃⁻; C1 to C20 carboxy anion, C6 to C20 aryloxy anion with or without at least one of halogen atom, nitrogen atom, oxygen atom, silicon atom, sulfur atom, and phosphorous atom; C1 to C20 alkoxy anion; C1 to C20 carbonate anion; C1 to C20 alkylsulfonate anion; C1 to C20 amide anion; C1 to C20 carbamate anion;

a is 1 or 0;

Z is BF₄⁻, ClO₄⁻, NO₃⁻, or PF₆⁻;

R¹² and R¹⁴ are selected from group consisting of methyl, ethyl, isopropyl, or hydrogen, R¹¹ and R¹³ are —[CH{(CH₂)₃N⁺Bu₃}₂] or —[CMe{(CH₂)₃N⁺Bu₃}₂],

Q is diradical for connecting two nitrogen atoms.

More specifically, in the above general formula (10), Q is trans-1,2-cyclohexylene or ethylene, X is 2,4-dinitrophenolate, 4-nitrophenolate, 2,4,5-trichlorophenolate, 2,4,6-trichlorophenolate, or pentafluorophenolate, Z is BF₄⁻.

More specifically, the complex compounds of the following general formulas (11) to (13) are used as the catalysts.

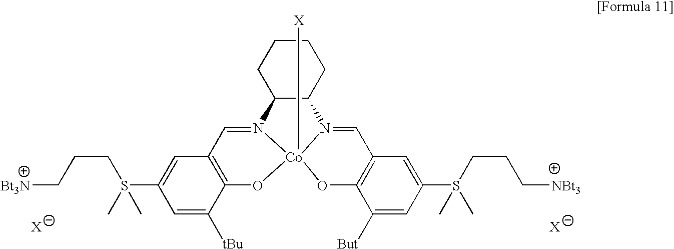

where: X is 2,4-dinitrophenolate.

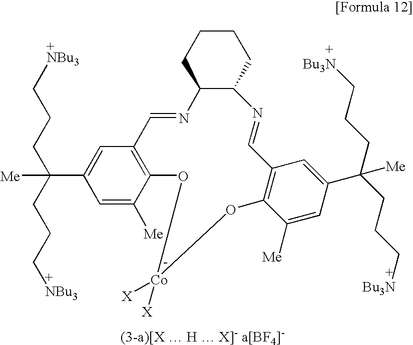

where: X is 2,4-dinitrophenolate.

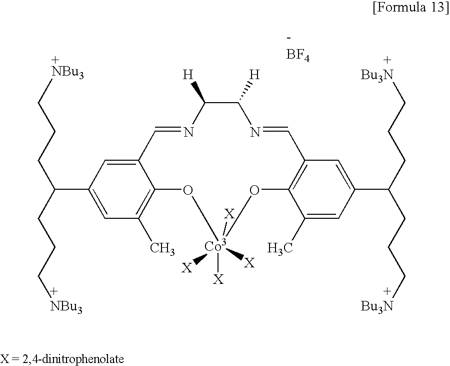

In addition, the resin composition may further include at least one of polycarbonate copolymer produced by reacting epoxide compound selected from group consisting of (C2-C10) alkylene oxide substituted or un-substituted halogen or alkoxy; (C4-C10) cycloalkylene oxide substituted or un-substituted halogen or alkoxy; and (C8-C10) styrene oxide substituted or un-substituted halogen, alkoxy, alkyl, or aryl with carbon dioxide. The polycarbonate copolymer serves to reinforce flexibility and a toughness of polycarbonate terpolymer, or reduce a heat seal initiation temperature, so that it is preferred that its glass transition temperature (T_{g}) is 0˜40° C. In this case, the ratio of the polycarbonate terpolymer to polycarbonate copolymer preferably is 5:95˜95:5 by weight.

In addition, the resin composition of the present invention may further include additives, such as dyes, pigments, fillers, antioxidants, UV blocking agents, antistatic agents, anti-blocking agents, slip agents, and the like, that are generally used in manufacturing a film or sheet, and a kind of additives will not be limited.

The scope of the present invention includes the film or sheet using the resin composition.

The film or sheet according to the present invention can be used as a single layer or at least two layers, and can be applied a field of container for food package by using a thermal molding, and the like.

The molding of the film or sheet according to the present invention is possible a single-layer or multi-layer production by a solvent casting, a melt extrusion, a co-extrusion, an extrusion coating, a wet lamination, a dry lamination, a up/downward blown, and the like. In addition, when laminating the multi-layer, a tie layer may be formed according to the need in order to improve the adhesive property with other resin layer.

In addition, the scope of the present invention includes a multi-layer film or multi-layer sheet including at least one layer. In other words, the multi-layer film or multi-layer sheet includes at least one layer of the film or sheet produced by using the resin composition of the present invention, and the remained layers may be possibly consisted with other resins. In addition, for the multi-layer film or multi-layer sheet, one side or both sides of the film or sheet using the resin composition according to the present invention are further laminated with the film or sheet including polycarbonate copolymer produced by reacting epoxide compound selected from group consisting of (C2-C10) alkylene oxide substituted or un-substituted halogen or alkoxy; (C4-C10) cycloalkylene oxide substituted or un-substituted halogen or alkoxy; and (C8-C20) styrene oxide substituted or un-substituted halogen, alkoxy, alkyl, or aryl with carbon dioxide. The scope of the present invention includes the multi-layer film for oxygen and moisture barrier properties as mentioned above. In this case, it is preferred that its glass transition temperature (T_{g}) is 0˜40° C.

### Advantageous Effects

The resin composition including polycarbonate copolymer according to the present invention has an improved oxygen and moisture barrier properties, an improved dimensional stability and surface adhesive properties, so that it is useful used as a package material of food package, and the like.

### BEST MODE

Hereinafter, the present invention will be described in more detail with reference to the following Examples, but the scope of the present invention is not limited thereto.

### [Production] 1 Synthesis of 3-metyl-5-[{BF₄⁻Bu₃N⁺(CH₂)₃}₂CH}]— salicylaldehyde compound

A title compound was prepared by hydrolyzing of a ligand represented by the following structure. The compound was synthesized according to the known method. (Angew. Chem. Int. Ed., 2008, 47, 7306-7309)

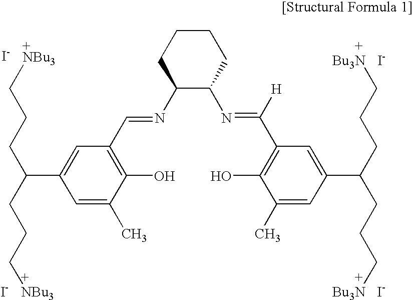

The compound of the structural formula 1 was dissolved in methylene chloride 4 mL, after dissolving, added HI aqueous solution 2N, 2.5 mL, and stirring for 3 hrs at 70° C. Water layer was removed, and then methylene chloride layer was washed with water. Then the methylene chloride layer was dried with an anhydrous magnesium chloride, and then solvent was removed under pressure. It was purified by using silica gel column chromatography of a mixture solution of methlyenechloride/ethanol 10:1, so that 0.462 g 3-methyl-5-[{I⁻Bu₃N⁺(CH₂)₃}₂CH}]-salicylaldehyde was yielded. (Yield: 95%). The compound was dissolved in ethanol 6 mL, and added AgBF₄ (0.225 g, 1.16 mmol). After stirring for 1.5 hrs at room temperature, the mixture compound was filtered. The solvent was removed by using pressure, and the mixture compound without solvent was purified by silica gel column chromatography of a mixture solution of methlyenechloride/ethanol 10:1, so that 0.410 g 3-methyl-5-[{BF₄⁻Bu₃N⁺(CH₂)₃}₂CH}]-salicylaldehyde compound was yielded. (Yield: 100%).

¹H NMR (CDCl₃): δ 11.19 (s, 1H, OH), 9.89 (s, 1H, CHO), 7.48 (s, 1H, m-H), 7.29 (s, 1H, m-H), 3.32-3.26 (m, 4H, —NCH₂), 3.10-3.06 (m, 12H, —NCH₂), 2.77 (septet, J=6.8 Hz, —CH—), 2.24 (s, 3H, —CH₃), 1.76-1.64 (m, 8H, —CH₂), 1.58-1.44 (m, 16H, —CH₂), 1.34-1.29 (m, 8H, —CH₂), 0.90 (t, J=7.6 Hz, 18H, CH₃) ppm. ¹³C {¹H} NMR (CDCl₃): δ 197.29, 158.40, 136.63, 133.48, 130.51, 127.12, 119.74, 58.23, 40.91, 32.51, 23.58, 19.48, 18.82, 15.10, 13.45 ppm.

### [Production] 2 Synthesis of Complex Compound 1

A complex compound 1 represented by the following general formula 13 was synthesized from 3-methyl-5-[{BF₄⁻Bu₃N⁺(CH₂)₃}₂CH}]-salicylaldehyde compound produced in Production 1.

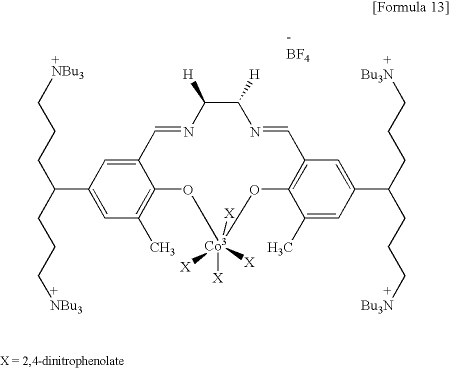

Etylenediamine dihydrochloride 10 mg (0.074 mmol), sodium t-butoxide 14 mg, and 3-methyl-5-[{BF₄⁻Bu₃N⁺(CH₂)₃}₂CH}]-salicylaldehyde compound 115 mg produced in Production 1 were weighted and putted in a vial in a dry box, and then ethanol 2 mL was added in the vial. The vial was stirred at room temperature over night. The reaction mixture was filtered, and ethanol was removed from the resulted filtrate under pressure. After removing ethanol, the filtrate was again dissolved in methylenechloride, and filtered once more. Co(OAc)₂ 13 mg (0.074 mmol) and ethanol 2 mL were added after removing solvent under pressure. The reaction mixture was stirred for 3 hrs at room temperature, and then solvent was removed under pressure. The resulted compound was washed with diethylene ether 2 mL two times, and then a solid compound was yielded. The solid compound was dissolved again in methylene chloride 2 mL, added 2,4-dinitrophenol 14 mg (0.074 mmol), and then stirred for 3 hrs under oxygen. The reaction mixture was added sodium 2,4-dinitrophenolate 92 mg (0.44 mmol), and stirred over night. The reaction mixture was filtered by using celite, the solvent was removed, and then a black blown solid compound was yielded. (149 mg, 100%). ¹H NMR (dmso-d₆, 40° C.): δ 8.84 (br, 2H, (NO₂)₂C₆H₃O), 8.09 (br, 2H, (NO₂)₂C₆H₃O), 8.04 (s, 1H, CH═N), 7.12 (s, 2H, m-H), 6.66 (br, 2H, (NO₂)₂C₆H₃O), 4.21 (br, 2H, ethylene-CH₂), 3.35-2.90 (br, 16H, NCH₂), 2.62 (s, 3H, CH₃), 1.91 (s, 1H, CH), 1.68-1.42 (br, 20H, CH₂), 1.19 (br, 12H, CH₂), 0.83 (br, 18H, CH₃) ppm. ¹H NMR (THF-d₈, 20° C.): δ 8.59 (br, 1H, (NO₂)₂C₆H₃O), 8.10 (br, 1H, (NO₂)₂C₆H₃O), 7.93 (s, 1H, CH═N), 7.88 (br, 1H, (NO₂)₂C₆H₃O), 7.05 (s, 1H, m-H), 6.90 (s, 1H, m-H), 4.51 (s, 2H, ethylene-CH₂), 3.20-2.90 (br, 16H, NCH₂), 2.69 (s, 3H, CH₃), 1.73 (s, 1H, CH), 1.68-1.38 (br, 20H, CH₂), 1.21 (m, 12H, CH₂), 0.84 (t, J=6.8 Hz, 18H, CH₃) ppm. ¹H NMR (CD₂Cl₂, 20° C.): δ 8.43 (br, 1H, (NO₂)₂C₆H₃O), 8.15 (br, 1H, (NO₂)₂C₆H₃O), 7.92 (br, 1H, (NO₂)₂C₆H₃O), 7.79 (s, 1H, CH—N), 6.87 (s, 1H, m-H), 6.86 (s, 1H, m-H), 4.45 (s, 2H, ethylene-CH₂), 3.26 (br, 2H, NCH₂), 3.0-2.86 (br, 14H, NCH₂), 2.65 (s, 3H, CH₃), 2.49 (br, 1H, CH), 1.61-1.32 (br, 20H, CH₂), 1.31-1.18 (m, 12H, CH₂), 0.86 (t, J=6.8 Hz, 18H, CH₃) ppm. ¹³C{¹H} NMR (dmso-d₆, 40° C.): δ 170.33, 165.12, 160.61, 132.12 (br), 129.70, 128.97, 127.68 (br), 124.51 (br), 116.18 (br), 56.46, 40.85, 31.76, 21.92, 18.04, 16.16, 12.22 ppm. ¹⁵N{¹H} NMR (THF-d₈, 20° C.): δ −154.19 ppm. ¹⁹N{¹H} NMR (dmso-d₆, 20° C.): δ −50.63, −50.69 ppm.

### [Production] 3 Synthesis of Copolymer (PPC) Using Carbon Dioxide/Propylene Oxide

Propylene oxide 1162 g (20.0 mol) having the dissolved complex compound 0.454 g (calculated according to a ratio of monomer/catalyst) was injected through a canola to 3 L autoclave reactor. A complex compound is the complex compound 1 produced by Production 2. Carbon dioxide was injected to the reactor using a pressure of 17 bar, and while a temperature of the reactor was increased by using a pre-adjusted temperature of circulation water bath of 80° C., the stirring was started. After 30 mins, time of a point that starts to decrease the pressure of carbon dioxide was measured, and recorded. After 2 hrs from the point, the reaction was stopped by removing the carbon dioxide gas. Propylene oxide 830 g was further added to the resulted viscous solution, thereby decreasing the viscosity of the solution, and was passed through silicagel [50 g, produced by MERK, 0.040˜0.063 mm size (230˜400 mesh)] pad, so that a colorless solution was yielded. The monomer was removed by vacuum pressing, and then a white solid 283 g was yielded. An average molecular weight (Mw) of the resulted polymer was 290,000, and a polydispersity index (PDI) was 1.30. The average molecular weight (Mw) and PDI of the resulted polymer were measured by using GPC.

### [Production] 4 Synthesis of CO₂/PO/CHO Terpolymer Using Carbon Dioxide/Propylene Oxide/Cyclohexene Oxide

Propylene oxide 622.5 g (10.72 mol) having the dissolved complex compound 0.406 g (calculated according to a ratio of monomer/catalyst) and cyclohexene oxide were injected through the canola to 3 L autoclave reactor. A complex compound is the complex compound 1 produced by Production 2. Carbon dioxide was injected to the reactor using a pressure of 17 bar, and while a temperature of the reactor was increased by using the pre-adjusted temperature of circulation water bath of 80° C., the stirring was started. After 30 mins, time of a point that starts to decrease the pressure of carbon dioxide was measured, and recorded. After 2 hrs from the point, the reaction was stopped by removing the carbon dioxide gas. Propylene oxide 830 g was further added to the resulted viscous solution, thereby decreasing the viscosity of the solution, and was passed through silica gel [50 g, produced by MERK, 0.040˜0.063 mm size (230˜400 mesh)] pad, so that a colorless solution was yielded. The monomer was removed by vacuum pressing, and then a white solid 283 g was yielded.

An average molecular weight (Mw) of the resulted polymer was 210,000, a polydispersity index (PDI) was 1.26, and a ratio of cyclohexene carbonate in the polymer was 25 mol %. The average molecular weight (Mw) and PDI of the resulted polymer were measured by using GPC, and the ratio of cyclohexene carbonate in the polymer was calculated by analyzing of ¹H NMR spectrum.

### Production 5

Terpolymer was produced by using same method with Production 4, and variously controlling the content ratio of propylene oxide (PO) to cyclohexene oxide (CHO). The glass transition temperature of the resulted terpolymer was measured, and the results were shown in the following Table 1:

TABLE 1

| Ratio PO/CHO in Ter-polymer by NMR (mol %) | | |
|---|---|---|
| PO | CHO | T_{g} (° C.) by DSC |
| 100 | 0 | 39 |
| 84 | 16 | 53.2 |
| 81 | 19 | 54.5 |
| 80 | 20 | 56.8 |
| 77 | 23 | 60 |
| 71 | 29 | 63.1 |
| 62 | 38 | 69.7 |
| 51 | 49 | 72.6 |
| 47 | 53 | 86.9 |
| 36 | 64 | 94.5 |

As shown in Table 1, it could be known that T_{g} increases in proportion to the increase in the content of CHO in Ter-polymer.

### Example 1

A film was molded by using CO₂/PO/CHO Ter-polymer produced by using the method of Production 4, and a dimensional stability and oxygen transmission rate of the film were measured.

PO/CHO in Ter-polymer is 75:25 (mol %), MW is 210,000, and T_{g} is 60° C.

Casting film was produced by using a single screw extruder having a screw diameter 19 mm and a screw L/D=28:1 as a film molding. T-die having 15 cm widths was used. For a temperature of extrusion, a barrel temperature was 120° C., 160° C., 160° C., Die temperature was set 160° C., and a screw RPM was 40 l/min.

A width of the film and thickness of the film were 12 cm and 50 μm, respectively.

The dimensional stability and the oxygen transmission rate were measured by the following procedures, and the results were shown in the following Table 2 and 3.

Measurement of Dimensional Stability: while the temperature of the film was maintained constantly, a size change was measured according to the passage of time. The sizes in a machine direction and a transverse direction were measured, respectively. Initially, 10 cm from MD and TD directions were marked, respectively, and then a length change was measured according to the passage of time. A room temperature (23° C.) experiment was performed while storing the film in a constant-temperature room that is maintained the constant-temperature and constant-humidity, and high temperature (55° C.) experiment was performed by using a convection oven.

Measurement of Oxygen Transmission Rate: it was measured by using Gas Transmission Rate Tester provided from Toyoseiki at 23° C.

TABLE 2
Dimensional Stability at Room Temperature (23° C.)

| Passage | | | | |
|---|---|---|---|---|
| of time | MD (cm) | MD (%) | TD (cm) | TD (%) |
| 0 | 10 | 100 | 10 | 100 |
| 3 | 10 | 100 | 10 | 100 |
| 17 | 10 | 100 | 10 | 100 |
| 41 | 10 | 100 | 10 | 100 |
| 92 | 9.95 | 99.5 | 10 | 100 |
| 161 | 9.9 | 99 | 10 | 100 |
| 185 | 9.9 | 99 | 10 | 100 |

TABLE 3
Dimensional Stability (55° C.)

| Passage | | | | |
|---|---|---|---|---|
| of time | MD (cm) | MD (%) | TD (cm) | TD (%) |
| 0 | 10 | 100 | 10 | 100 |
| 3 | 9.96 | 99.6 | 10 | 100 |
| 17 | 9.96 | 99.6 | 10 | 100 |
| 41 | 9.9 | 99 | 10 | 100 |
| 92 | 9.9 | 99 | 10 | 100 |
| 161 | 9.9 | 99 | 10 | 100 |
| 185 | 9.9 | 99 | 10 | 100 |

As shown in Table 2 and 3, it can be known that the dimensional stability at room temperature and 55° C. were maintained.

In addition, it can be known that the oxygen transmission rate (50 um) was 95 cc/m² atm day.

### Example 2

A film was molded by blending PPC produced by using the method of Production 3 and CO₂/PO/CHO Ter-polymer produced by using the method of Production 4. A dimensional stability and oxygen transmission rate of the molded film were also measured by using same method with the method of Example 1, and the results were shown in the following Table 4 and 5.

In this case, the weight ratio of Ter-polymer:PPC is 5:5 for blending, MW of Ter-polymer is 210,000 (PO:CHO=75:25 mol %), T_{g} of Ter-polymer is 60° C., MW of PPC is 290,000, and Tg of PPC is 33° C.

For a film molding, Casting film was produced by mixing Ter-polymer:PPC=5:5 weigh ratio, compounding in Twin extruder, and then using the single screw extruder. For condition of Twin extruder, a screw diameter was 40 mm, the twin extruder used a counter-rotating of screw L/D=7:1, the barrel temperature of extruder was set 120° C., 160° C., 160° C., 160° C. For a film molding, casting film was produced by using the single screw extruder having a screw diameter 19 mm and a screw L/D=28:1. T-die having 15 cm widths was used. For the temperature of extrusion, the barrel temperature was 120° C.-160° C.-160° C., Die temperature was set 160° C., and a screw RPM was 40 l/min.

The film was molded as the width 12 cm and thickness 55 μm.

TABLE 4
Dimensional Stability at Room Temperature (23° C.)

| Passage | | | | |
|---|---|---|---|---|
| of time | MD (cm) | MD (%) | TD (cm) | TD (%) |
| 0 | 10 | 100 | 10 | 100 |
| 23 | 10 | 100 | 10 | 100 |
| 46 | 10 | 100 | 10 | 100 |
| 134 | 10 | 100 | 10 | 100 |
| 183 | 10 | 100 | 10 | 100 |
| 232 | 9.8 | 98 | 10 | 100 |
| 326 | 9.8 | 98 | 10 | 100 |

TABLE 5
Dimensional Stability (55° C.)

| Passage | | | | |
|---|---|---|---|---|
| of time | MD (cm) | MD (%) | TD (cm) | TD (%) |
| 0 | 10 | 100 | 10 | 100 |
| 23 | 9.85 | 98.5 | 9.97 | 99.7 |
| 46 | 9.83 | 98.3 | 9.95 | 99.5 |
| 134 | 9.8 | 98 | 9.9 | 99 |
| 183 | 9.78 | 97.8 | 9.9 | 99 |
| 232 | 9.78 | 97.8 | 9.9 | 99 |
| 326 | 9.78 | 97.8 | 9.9 | 99 |

As shown in Table 4 and 5, it can be known that the dimensional stability at room temperature and 55° C. were maintained.

The oxygen transmission rate (50 μm) was 72 cc/m² atm day.

### Comparative Example 1

A film was produced by using PPC produced in Production 3. The film was produced by using same method with the method of Example 1, except for MW of PPC is 290,000, and T_{g} of PPC is 33° C., and thickness of film was 100 μm.

A dimensional stability and oxygen transmission rate of the molded film were also measured by using same method with the method of Example 1, and the results were shown in the following Table 6 and 7.

TABLE 6
Dimensional Stability (23° C.)

| Passage | | | | |
|---|---|---|---|---|
| of time | MD (cm) | MD (%) | TD (cm) | TD (%) |
| 0 | 10 | 100 | 10 | 100 |
| 3 | 9.4 | 94 | 10 | 100 |
| 17 | 8.9 | 89 | 10 | 100 |
| 41 | 8.55 | 85.5 | 10 | 100 |
| 92 | 8.4 | 84 | 10 | 100 |
| 161 | 8.3 | 83 | 10 | 100 |
| 185 | 8.3 | 83 | 10 | 100 |

TABLE 7
Dimensional Stability (55° C.)

| Passage | | | | |
|---|---|---|---|---|
| of time | MD (cm) | MD (%) | TD (cm) | TD (%) |
| 0 | 10 | 100 | 10 | 100 |
| 3 | 8.6 | 86 | 9.9 | 99 |
| 17 | 8.2 | 82 | 9.9 | 99 |
| 41 | 7.9 | 79 | 9.9 | 99 |
| 92 | 7.8 | 78 | 9.9 | 99 |
| 161 | 7.7 | 77 | 9.9 | 99 |
| 185 | 7.7 | 77 | 9.9 | 99 |

As shown in Table 6 and 7, it can be known that a contraction was not occurred in TD direction; however a contraction was occurred in MD direction because an orientation was mainly occurred in MD direction when molding a film. It can be also known that the contraction speed and degree at 55° C. were higher than those of room temperature. In addition, the oxygen transmission rate (100 μm) was 21 cc/m² atm day.

1. A resin composition for blocking oxygen and moisture comprising polycarbonate terpolymer produced by reacting different two epoxides compounds with carbon dioxide.

2. The resin composition for blocking oxygen and moisture of claim 1, wherein the epxides compounds are at least two selected from group consisting of (C2-C10) alkylene oxide substituted or un-substituted with halogen or alkoxy; (C4-C20) cycloalkylene oxide substituted or un-substituted with halogen or alkoxy; and (C8-C20) styrene oxide substituted or un-substituted with halogen, alkoxy, alkyl, or aryl.

3. The resin composition for blocking oxygen and moisture of claim 2, wherein the polycarbonate terpolymer is represented by the following general formula 1: 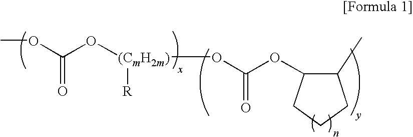
Where: m is 2˜10, n is 1˜3, R is hydrogen, (C1-C4) alkyl, or —CH₂—O—R′ [here, R′ is (C1-C8) alkyl], and x:y is 5:95˜95:5.

4. The resin composition for blocking oxygen and moisture of claim 3, wherein a glass transmission temperature (T_{g}) of the polycarbonate terpolymer represented by the above general formula 1 is 40˜110° C.

5. The resin composition for blocking oxygen and moisture of claim 4, wherein the resin composition further includes at least one polycarbonate copolymer produced by racing epoxide compound selected from group consisting of (C2-C10) alkylene oxide substituted or un-substituted with halogen or alkoxy; (C4-020) cycloalkylene oxide substituted or un-substituted with halogen or alkoxy; and (C8-C20) styrene oxide substituted or un-substituted with halogen, alkoxy, alkyl, or aryl, with carbon dioxide.

6. The resin composition for blocking oxygen and moisture of claim 5, wherein a glass transmission temperature (T_{g}) of the polycarbonate copolymer is 0˜40° C.

7. The resin composition for blocking oxygen and moisture of claim 6, wherein a weight ratio of polycarbonate terpolymer to polycarbonate copolymer is 5:95˜95:5.

8. A sheet produced by using the resin composition for blocking oxygen and moisture according to any one of claim 1.

9. A multi-layer sheet for blocking oxygen and moisture including at least one sheet according to claim 8.

10. A multi-layer sheet for blocking oxygen and moisture laminated with at least two sheets according to claim 8.

11. A multi-layer sheet for blocking oxygen and moisture which is further laminated to a following sheet on one side or both sides of the sheet according to claim 8,
wherein the sheet includes polycarbonate copolymer produced by reacting epoxide compound selected from group consisting of (C2-C10) alkylene oxide substituted or un-substituted with halogen or alkoxy; (C4-C20) cycloalkylene oxide substituted or un-substituted with halogen or alkoxy; and (C8-C20) styrene oxide substituted or un-substituted with halogen, alkoxy, alkyl, or aryl, with carbon dioxide.

12. The multi-layer sheet for blocking oxygen and moisture of claim 11, wherein a glass transmission temperature (T_{g}) of the polycarbonate copolymer is 0˜40° C.
